(19) United States
(12) Patent Application Publication
(10) Pub. No.: US 2008/0134854 A1
(43) Pub. Date: Jun. 12, 2008

(54) Tenoner

(76) Inventor: Jack Yang, Taichung County (TW)

Correspondence Address: Joe McKinney Muncy, PO Box 1364, Fairfax, VA, 22038-1364, US

(21) Appl. No.: 11/590,763

(22) Filed: Nov. 1, 2006

(51) Int. Cl. B26D 7/06

(52) U.S. Cl. 83/422

(57) ABSTRACT

A tenoner includes a chassis which has a moving dock having a sliding member on the bottom run through by a transverse sliding rod and movable thereon on the top. A directing wheel is provided and located on the front side of the sliding member leaning and rotating on a lower side of a positioning rod. A directing rod coupled with the moving dock having a rear side fastened to a connection board is provided that is movable on a front jagged surface of the positioning rod. The connection board is fastened to an anchor ring located on the top of a driving motor having a spindle fastened to a cutter extended above the connection board to perform cutting operation on a work piece. The moving dock can be moved to all directions smoothly to move the cutter forwards and rearwards. The driving motor also can be removed quickly.

### FIELD OF THE INVENTION

The present invention relates to a tenoner and particularly to a tenon fabrication machine that moves cutters smoothly and steadily, and allows a driving motor to be installed and removed quickly.

### BACKGROUND OF THE INVENTION

A conventional tenoner as shown in FIG. 1 mainly includes a chassis 1 with a driving motor 2 mounting on the top in a upright manner. The driving motor 2 has a spindle facing downward to hold a cutter (not shown in the drawing). The cutter has to be moved forwards and rearwards and leftwards and rightwards against a wooden work piece to perform cutting operation to form a row of tenon ditches (or tenon lugs) that are equally spaced from one another (as shown in FIG. 2). Hence the driving motor 2 has to be moved reciprocally left and right. The driving motor 2 is fixedly mounted onto a moving dock 3 and moved left and right therewith. The moving dock 3 has an opening (not shown in the drawings) in the center to hold the driving motor 2. The cutter is located beneath the moving dock 3 to cut the work piece. The moving dock 3 has the bottom run through transversely by a sliding rod 4 and is movable reciprocally left and right on the sliding rod 4. The moving track of the cutter has to be very precise. A slight deviation of tolerance could result in mismatch of the tenon ditches and tenon lugs. Hence the cutter must be fastened firmly, and coupling of the moving dock 3 and the sliding rod 4 must be very smooth and steady.

In the event that malfunction occurs to the driving motor 2, and removal of the driving motor 3 for repairs is necessary, the entire moving dock 3 has to be removed from the two sliding rods 4. Removing and reinstallation have to be done by skillful professionals. Due to the moving dock 3 is coupled and involved, removing and reinstallation are tedious and troublesome.

### SUMMARY OF THE INVENTION

In view of the aforesaid disadvantages occurred to the conventional tenoner, the primary object of the present invention is to provide a tenoner that has a chassis with a moving dock on the top. The moving dock has a sliding member on the bottom that is coupled on a sliding rod located transversely at the front side of the chassis. The moving dock is movable left and right on the sliding rod. The sliding member has a directing wheel at the front side. The directing wheel leans on a positioning rod from below. The positioning rod has notches on the front side. A directing rod is provided movable at the front of the positioning rod. The directing rod has a front end coupled with the moving dock. The moving dock has a rear side fastened to a connection board. The connection board has an opening in the center which is surrounded by a plurality of apertures. A driving motor is provided on the bottom of the connection board. The driving motor has an anchor ring on the top. The anchor ring has screw holes corresponding the apertures to be fastened by fastening elements after running through the connection board. Hence the driving motor can be moved left and right with the moving dock. The driving motor has a spindle on the top to hold a cutter. The cutter is exposed above the connection board to cut a work piece to form tenon ditches or tenon lugs. Through the moving dock which is slidable left and right the cutter can be moved flexibly forwards and rearwards. When there is a need to remove the driving motor, it can be accomplished by unfastening the fastening elements on the connection board. Operation is simple and fast.

The foregoing, as well as additional objects, features and advantages of the invention will be more readily apparent from the following detailed description, which proceeds with reference to the accompanying drawings.

### BRIEF DESCRIPTION OF THE DRAWINGS

FIG. 1 is a perspective view of a conventional tenoner.

FIG. 2 is a schematic view of a work piece with tenon ditches and tenon lugs formed by cutting of a tenoner

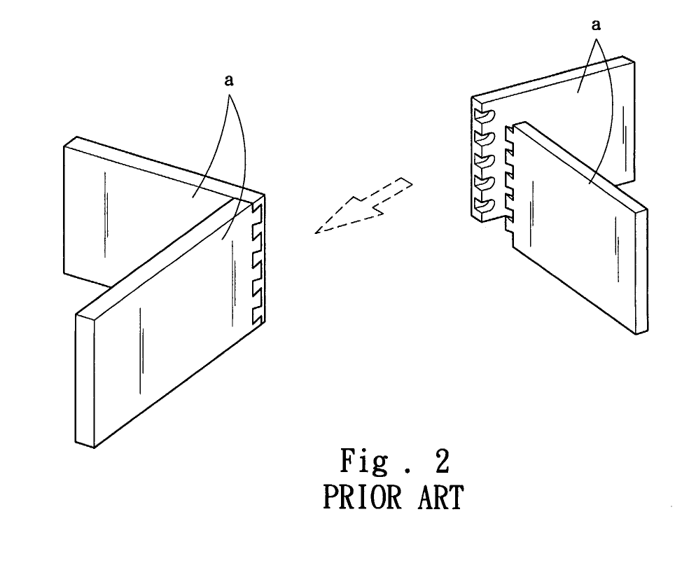

FIG. 3 is a perspective view of an embodiment of the present invention.

FIG. 4 is a fragmentary exploded view of an embodiment of the present invention.

FIG. 5 is a fragmentary perspective view of an embodiment of the present invention.

FIG. 6 is a fragmentary sectional view of an embodiment of the present invention.

### DETAILED DESCRIPTION OF THE PREFERRED EMBODIMENT

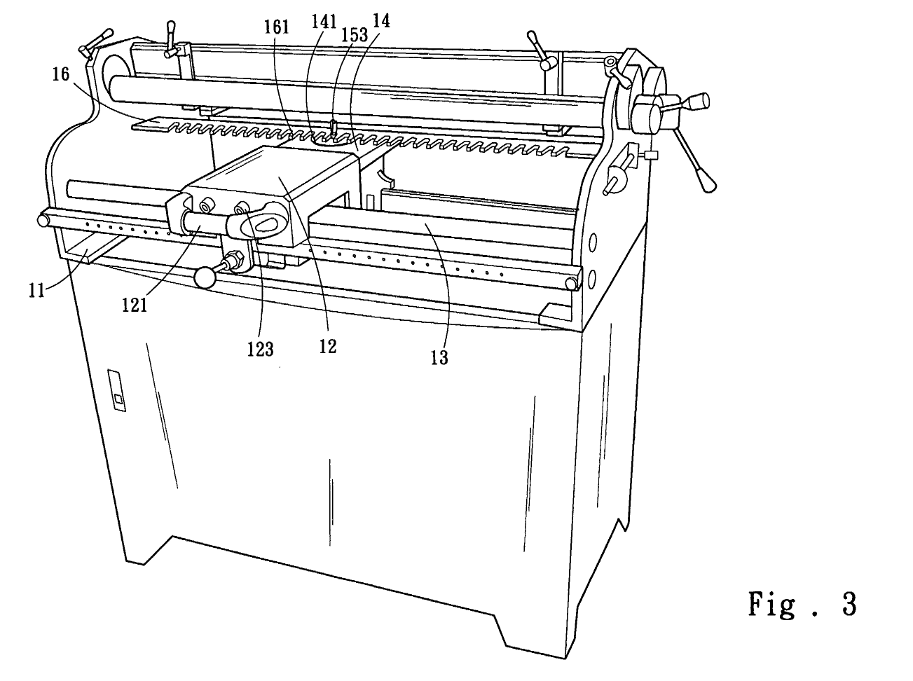

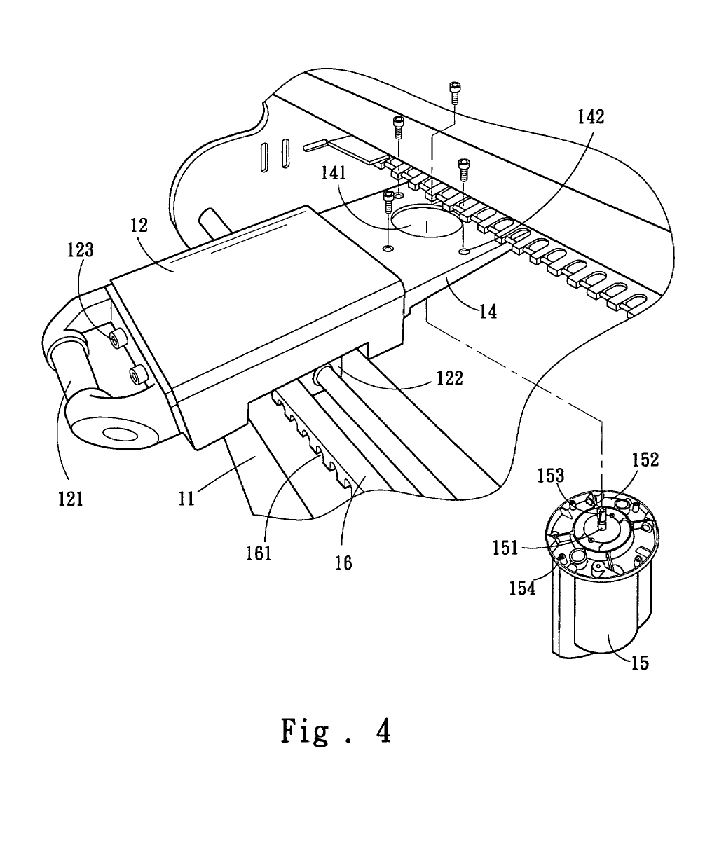

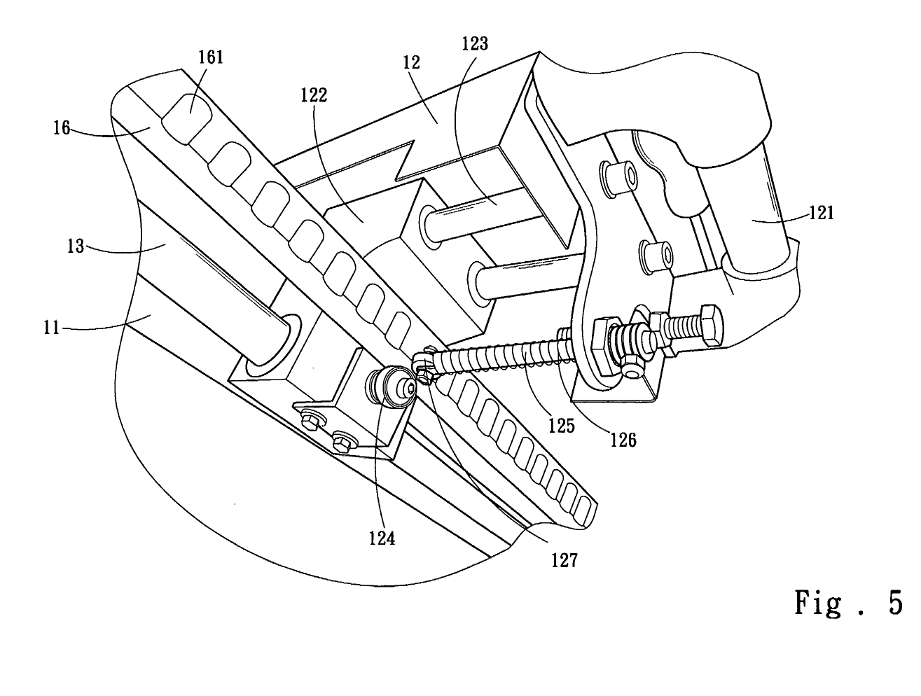

Please refer to FIGS. 3 and 4, the tenoner according to the invention includes a chassis 11 which has a rectangular moving dock 12 on the top formed like a shell. There is a handgrip 121 at the front side of the moving dock 12. On the bottom of the moving dock 12, there is a T-shaped sliding member 122. Referring to FIG. 5, the sliding member 122 has the bottom run through by a sliding rod 13 located at the front side of the chassis 11. The sliding member 122 is movable left and right on the sliding rod 13 to drive the moving dock 12. There is a directing wheel 124 located on the front side of the sliding member 122. The moving dock 12 further has a front wall run through by a directing rod 125 which is coupled with a spring 126 on the periphery. The directing rod 125 has a guiding portion 127 on a distal end. The moving dock 12 further is run through by two screw bars 123 in a forward and rearward manner. The two screw bars 123 also run through the sliding member 122.

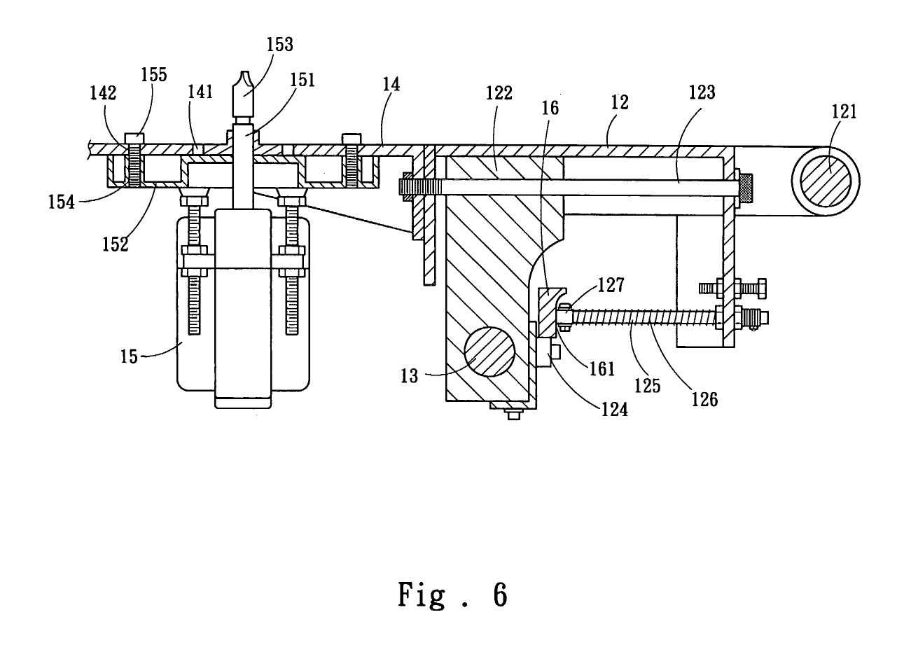

The tenoner of the invention also includes a connection board 14 located on a rear side of the moving dock 12. The screw bars 123 have respectively a distal end fastened to the bottom of the connection board 14 as shown in FIG. 6. The connection board 14 has a round opening 141 in the center of the top surrounding by four apertures 142.

The tenoner of the invention further includes a driving motor 15 which has a rotating spindle 151 in the center of the top thereof and a circular anchor ring 152 located on an upper side thereof. The spindle 151 runs through the anchor ring 152 on an upper side to be fastened to a cutter 153. The anchor ring 152 further has screw holes 154 corresponding to the apertures 142 to be fastened by fastening elements 155 (such as bolts) to the apertures 142 so that the driving motor 15 is fastened to the connection board 14.

A transverse positioning rod 16 also is provided above the chassis 11 that has a plurality of notches 161 on the front side formed in an equally spaced manner. The notches 161 are to be leaned by the guiding portion 127 of the directing rod 125 so that the directing rod 125 can be moved on the jagged surface of the positioned rod 16 to drive the moving dock 12 synchronously, meanwhile the cutter 153 is moved forwards and rearwards at the same time according to the jagged surface of the positioning rod 16 to cut the work piece simultaneously to form tenon ditches (or tenon lugs) at a constant interval.

By means of the construction set forth above, during cutting the tenon ditches on the work piece, the moving dock 12 is moved rightwards, and the directing wheel 125 at the bottom of the moving dock 12 leans on the lower side of the position rod 16. The sliding member 122 is held and drives the moving dock 12 forwards and rearwards through the directing rod 125 so that the cutter 153 is moved forwards and rearwards firmly and smoothly.

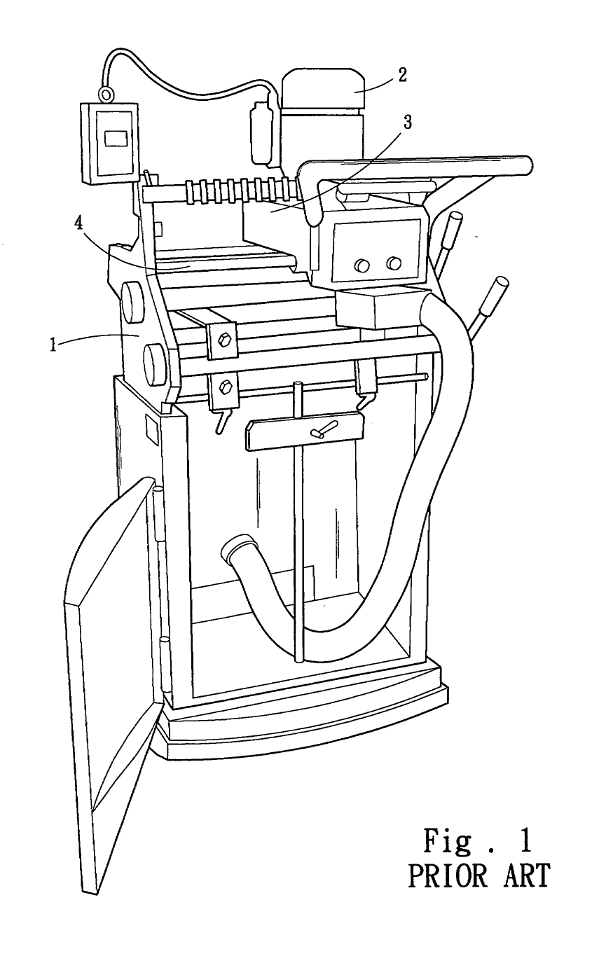

In the event that malfunction occurs to the driving motor 15 and removing is needed to do repairs, it can be accomplished by unfastening the fastening elements 155 on the top of the connection board 14 without removing the moving dock 12. Compared with the conventional technique of installing and removing the driving motor 2 shown in FIG. 1, the process of the present invention is much simpler and quicker. The driving motor 15 can be removed without relying on skillful professionals. Installation on the connection board 14 also can be done quickly.

Prototypes of the invention have been made and tested with desired results. The object and functions previously discussed have been achieved satisfactorily. It offers a significant improvement over the conventional techniques.

While the preferred embodiment of the invention has been set forth for the purpose of disclosure, modifications of the disclosed embodiment of the invention as well as other embodiments thereof may occur to those skilled in the art. Accordingly, the appended claims are intended to cover all embodiments which do not depart from the spirit and scope of the invention.

What is claimed is:

1. A tenoner comprising:
a chassis which has a transverse sliding rod and a positioning rod on the top thereof, the positioning rod having a plurality of notches on a front side in an equally spaced manner;
a moving dock which has a sliding member on the bottom run through by the sliding rod, a directing wheel which is located on a front side of the sliding member and below the positioning rod and movable along the positioning rod, and a front wall run through by a directing rod which is coupled with a spring on the periphery and has a guiding portion on a distal end thereof; the guiding portion being movable transversely along a front wall of the positioning rod, the bottom of the moving dock being run through by at least two screw bars in a forward and rearward fashion, the screw bars having respectively a distal end fastened to a connection board, the connection board being fastened to a driving motor which is located beneath the connection board and has a spindle on the top thereof, the spindle being fastened to a cutter which is extended above the connection board.

2. The tenoner of claim 1, wherein the sliding member is formed in T-shape.

3. The tenoner of claim 1, wherein the top of driving motor is fastened to an anchor ring which has a plurality of screw holes on the periphery, the connection board having an opening in the center of the top thereof to be run through by the spindle of the driving motor and a plurality of apertures around the opening to receive respectively a fastening element to fasten to the screw holes of the anchor ring.

4. The tenoner of claim 1, wherein the moving dock is a rectangular shell.
